(19) United States
(12) Patent Application Publication
(10) Pub. No.: US 2026/0063480 A1
(43) Pub. Date: Mar. 5, 2026

(54) FORCE SENSOR AND EVALUATION CIRCUIT

(71) Applicant: Infineon Technologies AG, Neubiberg (DE)

(72) Inventor: Udo AUSSERLECHNER, Villach (AT)

(21) Appl. No.: 19/306,276

(22) Filed: Aug. 21, 2025

(30) Foreign Application Priority Data
Aug. 29, 2024 (DE) 102024208241.4

(51) Int. Cl. G01L 1/14; G01L 1/26

(52) U.S. Cl. CPC G01L 1/14; G01L 1/26

(57) ABSTRACT

A force sensor includes a deformation body configured to be subjected to a force and to undergo a deformation dependent on a stiffness of the deformation body under the influence of the force; at least a first coil arranged at a first lateral position along the deformation body at a first distance from the deformation body and configured to form a first signal characteristic, which is described by a first measured value, based on a size of the first distance at the first lateral position; and a second coil arranged at a second lateral position along the deformation body at a second distance from the deformation body and configured to form a second signal characteristic, which is described by a second measured value, based on a size of the second distance at the second lateral position The deformation of the deformation body changes the first and the second distance differently.

### CROSS-REFERENCE TO RELATED APPLICATION

This application claims priority to Germany Patent Application No. 102024208241.4 filed on Aug. 29, 2024, the content of which is incorporated by reference herein in its entirety.

### TECHNICAL FIELD

Example implementations of the present implementation relate to a force sensor and to a corresponding evaluation circuit for the force sensor. Further example implementations relate to a force sensor having an evaluation circuit as well as to a corresponding method and computer program. In general, the implementation is in the field of inductive force sensors.

### BACKGROUND

Force measurement can be found in many applications, such as when determining the brake pedal force or brake caliper force.

A conventional representative of force sensors is based on a module having a spring or forming element that sags under the effect of an applied force that is intended to be measured. Strain gages are adhesively bonded to this spring element. Their resistance changes due to the load applied. The measuring devices are connected in a manner of a Wheatstone bridge. A voltage is supplied by a circuit and the output is connected to an amplifier. The small output voltage of the bridge is amplified and corrected for temperature drift and offset and output. A weak point of these conventional force sensors is the exact and reliable fastening of the strain gages to the spring element.

### SUMMARY

The object of the present implementation is to create a concept that enables a force sensor system and is more robust against temperature drift, lifetime drift and overloading.

The object is achieved using the subject matter of the independent patent claims.

Example implementations of the present implementation provide a force sensor having a deformation body, at least a first and a second coil. The deformation body is configured to be subjected to a force and to undergo a deformation dependent on a (bending) stiffness of the deformation body under the influence of the force. The first coil is arranged at a first lateral position along the deformation body at a first distance from the deformation body and is configured to form a first signal characteristic (such as a resonant frequency, an impedance, an inductance or a variable derived therefrom), which is described by a first measured value, based on a size of the first distance at the first lateral position. The second coil is arranged at a second lateral position along the deformation body at a second distance from the deformation body and is configured to form a second signal characteristic (such as a resonant frequency, an impedance, an inductance or a variable derived therefrom), which is described by a second measured value, based on a size of the second distance at the second lateral position. The deformation of the deformation body changes the first and the second distance differently. The force can be determined by an evaluation circuit which is configured to determine the force as a function of at least the first measured value (using a first coefficient) and the second measured value (using a second coefficient), wherein the first and the second coefficient are dependent on the stiffness of the deformation body. Here, the first measured value is multiplied by a first coefficient, for example, and the second measured value is multiplied by a second coefficient, for example.

According to example implementations, the first signal characteristic may comprise a first resonant frequency or impedance or inductance (Lm1) or a first variable derived therefrom, such as an oscillator frequency, and the second signal characteristic may comprise a second resonant frequency or impedance or inductance (Lm2) or a first variable derived therefrom. Such signal characteristics can be determined by the evaluation circuit (also called excitation circuit) which excites the coil 18 or 19 according to the example implementation, for example like in a resonant circuit using a signal, such as an alternating voltage, in order to determine the resonant frequency (which depends nonlinearly on the inductance (2*pi*fres=1/sqrt(Lm*C)). The evaluation circuit is configured according to example implementations to excite the first and/or second coil 18 and 19 with an alternating voltage signal and/or to measure a first and second impedance as the first and the second measured value.

A further example implementation provides an evaluation circuit for use with a force sensor, which has a deformation body, at least a first coil and a second coil, wherein the deformation body is configured to be subjected to a force and to undergo a deformation dependent on a (bending) stiffness of the deformation body under the influence of the force; wherein the first coil is arranged at a first lateral position along the deformation body at a first distance from the deformation body and is configured to form a first signal characteristic, which is described by a first measured value, based on a size of the first distance at the first lateral position; and wherein the second coil is arranged at a second lateral position along the deformation body at a second distance from the deformation body and is configured to form a second signal characteristic, which is described by a second measured value, based on a size of the second distance at the second lateral position; wherein the deformation of the deformation body changes the first and the second distance differently. The evaluation circuit is configured to determine the force as a function of at least the first measured value and the second measured value, wherein the first and the second coefficient are dependent on the stiffness of the deformation body. Here, the first measured value is multiplied by a first coefficient, for example, and the second measured value is multiplied by a second coefficient, for example.

A further example implementation provides a method for determining a force using a force sensor, which has a deformation body, at least a first coil and a second coil, wherein the deformation body is configured to be subjected to a force and to undergo a deformation dependent on a (bending) stiffness of the deformation body under the influence of the force; wherein the first coil is arranged at a first lateral position along the deformation body at a first distance from the deformation body and is configured to form a first signal characteristic, which is described by a first measured value, based on a size of the first distance at the first lateral position; and wherein the second coil is arranged at a second lateral position along the deformation body at a second distance from the deformation body and is configured to form a second signal characteristic, which is described by a second measured value, based on a size of the second distance at the second lateral position; wherein at least the first distance at the first lateral position varies based on the deformation of the deformation body, and wherein the deformation of the deformation body changes the first and the second distance differently; comprising the following step of: determining the force based on a linear combination of at least the first measured value (using a first coefficient) and the second measured value (using a second coefficient), wherein the first and the second coefficient are dependent on the stiffness.

According to example implementations, the implementation may also be computer-implemented. Therefore, a method provides a computer program for carrying out this method when the method is carried out on a processor.

### BRIEF DESCRIPTION OF THE DRAWINGS

Developments are defined under claims. Example implementations of the present implementation are explained with reference to the accompanying drawings, in which:

FIG. 1 shows a schematic block diagram of a force sensor having two coils and a deformation body according to a basic example implementation;

FIG. 2 shows a schematic block diagram of a force sensor having three coils according to an extended example implementation;

FIG. 3 shows a schematic block diagram of a force sensor having deformation bodies mounted on two sides according to a further example implementation;

FIG. 4 shows a schematic block diagram of a force sensor having coils packaged in a sensor chip according to further example implementations;

FIG. 5 shows a schematic block diagram of a force sensor having a cranked deformation body according to example implementations;

FIG. 6 shows a schematic block diagram of a force sensor for explaining the measured values in a deformation body with an unknown geometry according to example implementations;

FIG. 7 shows a schematic block diagram of a force sensor for explaining the measured values in when a drift prevails according to example implementations;

FIG. 8 shows a schematic block diagram of a force sensor for explaining the measured values in the presence of a drift superimposed with a force according to example implementations; and

FIG. 9 shows a schematic block diagram of an evaluation circuit according to example implementations.

### DETAILED DESCRIPTION

Before example implementations of the present implementation are explained below with reference to the accompanying drawings, it should be noted that identically acting elements and structures are provided with identical reference signs, and therefore the description thereof is applicable to one another or interchangeable.

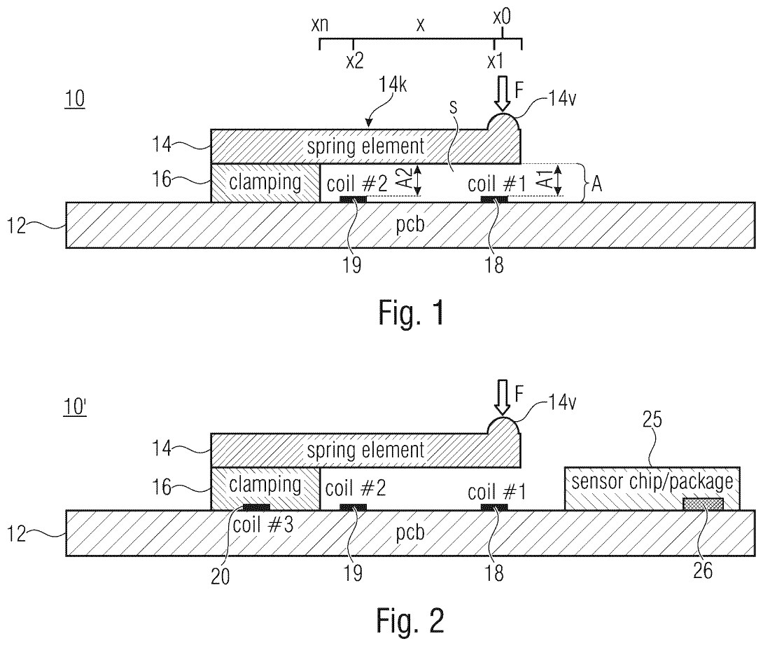

FIG. 1 shows a force sensor 10 which is applied here by way of example to a printed circuit board 12 (e.g., a printed circuit board (PCB)). The force sensor 10 comprises, as central elements, the deformation body 14 which is bendably mounted over a mounting region 16, for example. As further central elements, a first and a second coil are provided and are provided with the reference signs 18 and 19. The coils 18 and 19 are arranged, for example, on the PCB 12, to be precise laterally in a region in which the element 14 is also provided. The deformable element 14 is arranged substantially parallel to the PCB 12 through the mounting 16. The deformation element 14, also referred to as a spring 14 below, has a cantilever 14k here. This cantilever 14k protrudes from the support region or the clamping region 16. For example, the coils 18 and 19, as seen laterally, can be provided below the cantilever 14k.

The deformation element 14 is realized, for example, as a bending bar or cantilever 14k and is consequently arranged at a distance A from this PCB 12. The distance A is defined here by the height of the mounting element 16. This results in a gap s between the deformation body 14 and the PCB 12, which forms the distance A1 in the region of the coil 18 and forms the distance A2 in the region of the coil 19.

The deformation element 14, also referred to as a spring 14 below, has a cantilever 14k here. This cantilever 14k protrudes from the support region or the clamping region 16. For example, the coils 18 and 19, as seen laterally, can be provided below the cantilever 14k. The deformation body 14 or the cantilever 14 formed here has a cantilever length x, wherein, for example, the force F is applied at the position x0 and the cantilever element 14 is permanently mounted at the position xn by way of the (support) mounting region 16. The length x represents the length of the cantilever 14k. Starting from the lever arms between xn and x0, the deformation element 14 is bent along a bending line when force is applied by the force F. This means that the deformation body 14 is configured to undergo bending as deformation or to be deformed according to a bending line that is dependent on the stiffness. The bending, and thus also the bending line, depends on the stiffness of the element 14 along the cantilever region which extends over the length x. Further dependencies may be present with respect to the lever arm x, wherein the lever arm is defined by the first lateral position and a position x1 of the mounting of the deformation body xn and/or the force application point xo. As a result of the deformation, the distance A1 at the position x1 and the distance A2 at the position x2 change. Since the positions are freely distributed between the support xn and the force application point 14v, the distances A1 and A2 change differently when force is applied k. In other words, at least the first distance A1 at the first lateral position x1 varies based on the deformation of the deformation body 14 and/or the second distance A2 at the second lateral position x2 varies based on the deformation of the deformation body 14.

In the following consideration, it is assumed that the deformation element 14 comprises a conductive material, for example is produced from a metal, has a metal layer or is at least partially metalized. The first coil 18 is configured, based on the first distance A1 at the first lateral position x1, to form a first signal characteristic, such as an impedance or inductance. Analogously, the second coil 19 at the second lateral position x2 is configured, based on the second distance A2, to likewise form a second signal characteristic, such as again an inductance or an impedance. The first and second signal characteristics depend on the first and second distances A1 and A2. The first signal characteristic can be described by a first measured value, while the second signal characteristic can be described by a second measured value. In other words, the first coil 18 and the second coil 19 form a kind of distance sensor for determining the distances A1 and A2. Since the distances A1 and A2 vary differently based on the force applied k, this signal behavior can also be observed in the first and second signal characteristics. That is to say, for example, the first and second measured values likewise behave differently. An evaluation circuit makes use of this property.

According to example implementations, force F can be determined by an evaluation circuit (not shown) which is configured to determine the force F as a function, e.g., a linear function (e.g., in particular a linear function, a predominantly linear function, a largely linear function or a regionally linear function or a quasi-linear function), at least of the first measured value (using a first coefficient) and the second measured value (using a second coefficient). The first and the second coefficient depend here on the stiffness of the deformation body. From another point of view, this means that the coefficients depend on the stiffness, in which case the force is initially not yet known, but is determined using the predefined fixed coefficients and the measured inductances. Here, the first measured value is multiplied by a first coefficient, for example, and the second measured value is multiplied by a second coefficient, for example.

Since the stiffness is related to the bending line, it can also be the, according to further example implementations, that the first and the second coefficient are dependent on the bending line of the deformation body 14 at standard load F (e.g., maximum load). For example, the function can be a linear combination that has the measured values as input values, taking the coefficients into account. Before discussing details of this, it should be noted here that the function according to example implementations can be a linear function, a predominantly linear function, a regionally linear function or a quasi-linear function. The background is that the deformation body 14 does not have a linear behavior in all regions, but can also develop a non-linear behavior, in which case the function then describes the linear behavior only for this region. Even with a perfectly linear deformation behavior of the deformation body 14, deformation portions of the clamping region 16 and the base plate 12 as well as adhesive joints between these elements can cause a non-linear deformation behavior. In addition, the function does not have to be determined exactly, but can be approximated, and so not necessarily a linear function, but also a different function, can be present, which describes the behavior of the deformation body 14 in relation to the two signal characteristics of the coils 18 and 19.

Excursus of the linear combination: In mathematics, a linear combination of x,y is defined as a*x+b*y, in which case a constant c can be added: a*x+b*y+c. c can be negligibly small; in practice, another small or negligibly small quadratic or cubic term or higher-order term can also be added in x,y (e.g., d*x*y+c*x\hat{ }2+f*y\hat{ }2). These terms are used, for example, to increase the accuracy, in which case their coefficients may also be dependent on the stiffness of the deformation body 14. Therefore, the function for determining or estimating the force is described as a substantially linear function of both impedance parameters x,y, wherein the coefficients before the impedance parameters a,b,c,d,e,f are dependent on the stiffness of the deformation body. “Substantially” and “estimated” are redundant.

Now that the structure has been explained above, the operating principle is discussed below. The force sensor 10 uses, for example, a metallic deformation body 14, for example a spring, on which the force F is exerted. The coil 18 or 19 is placed near the spring 14 (distance of, for example, 0.5 mm), but is not in contact with the spring. The evaluation circuit (not shown) measures the impedance of the coils 18 and 19, e.g., the inductance at 25 MHz. When the force F deflects the spring 14, the distance A between the metal body 14 and the coils 18 and 19 changes, changing the inductances of the coils 18 and 19. It is measured and used to quantitively determine the force F. The coils 18 and 19 as well as the coil circuit (evaluation circuit) thus resemble an inductance proximity switch/sensor. According to example implementations, it would be conceivable for the coils 18 and 19 to be arranged, for example, in a sensor chip (single chip solution) or on a printed circuit board 12 (PCB) as shown, with great variety in terms of size and shape. For example, the spring is usually deflected with a maximum force of 50 μm, and so the coil characteristics of the coils 18 and 19 preferably have a resolution of the distance between the coils and the metal spring of at least 50 nm. This very small distance increment of 50 nm can also be caused, for example, by thermal or hygroscopic expansion of the fastening region 16 or curvature of the board 12, which can lead to an error in the force measurement. This error is reduced according to example implementations by the force sensor system not only measuring the distance between the spring and a coil, but measuring the deformation of the spring caused by the force using two or more coils. The aim of the force sensor system is thus to detect the deformation of the spring, regardless of any change in the position of the spring (displacement or rotation).

The use of at least two coils 18 and 19, which experience different distance changes in the distance A1 and A2 under load of the force F, has the advantage that a “differential spring” evaluation or “differential coil” evaluation is thus made possible. By using two spaced-apart coils 18 and 19, as already explained in detail above, two different distances A1 and A2 are detected starting from the deformation of the two sections of the spring 14. By virtue of the clamping explained, the spring 14 is constructed in such a way that both distances A1 and A2 are deflected differently, and the sensor system 10 detects the difference between the deflections A1 and A2. This makes it possible to compensate for drifts caused, for example, by thermal expansion. The background is that, due to a drift, for example resulting from thermal expansion, the distance between the metal spring or sensing coil can vary by several nanometers even at zero force, which leads to error measurements. The thermal expansion or generally the drift affects the shape of the spring 14, the spring holder or clamping 16, the PCB 12 or the chip package (also not shown). As a result of the fact that as a rule both distances A1 and A2 are equally affected in the case of such drifts, it is advantageously possible to compensate for drifts, in particular drifts due to thermal expansion, so that these do not affect the measurement.

A development of the arrangement from FIG. 1, in which three coils are used, is explained below with reference to FIG. 2.

FIG. 2 shows the sensor arrangement 10′, which is comparable to the sensor arrangement 10, wherein a third coil 20 is provided in the region of the spring holder or clamping 14. In addition, a sensor or chip package 25 is arranged on the PCB 12 next to the deformation body 14, in which the evaluation circuit 26 can be arranged. As in the example implementation from FIG. 1, the coils 18, 19 and 20 are arranged here on the surface of the PCB 12. The sensor chip is also arranged on the same surface. It should be noted that, according to further example implementations, of course the coils 18, 19 and 20 may be embedded on the surface or may be formed in the metallization of the PCB. Preferably, the coils 18, 19 and 20 are planar coils produced using one or more metallization layers of the PCB which are usually used for the conductive connection of electrical components on the PCB. However, the coils can also be fastened to the PCB as discrete components. The three coils 18, 19 and 20 can be arranged on a line, but need not be arranged on a line, but can also be arranged on a curve, as seen from a lateral perspective. The deflection in the region of the coil 18 is greater than the deflection in the region of the coil 19 when the force F is applied, while the coil 20 is not deflected in the region of the clamping 16 provided that the clamping is perfectly rigid. However, implementations are also conceivable where the clamping 16 is not perfectly rigid, since it may consist of a plastic which has unavoidable flexibility as well as relatively strong expansion in the event of a temperature increase and volume swelling due to moisture absorption from the environment. Generally, however, the deflection of the spring body in the region of the coil 19 is smaller than in the region of the coil 18 and greater than in the region of the coil 20. In order to ensure this, according to example implementations, the position of the coils 18, 19 and 20 directly below these critical regions of the spring 14 can be defined. Technically, the coil 18 has a greater change in its impedance with greater sensitivity to the force F than the coils 19 and 20. The coil 20 has a virtually constant impedance due to its arrangement. By using the evaluation circuit 26, which is arranged, for example, in the sensor chip/package 25, these impedances can be measured and compared with each other in order to estimate the force. The estimation is carried out by using a formula which contains the mechanical stiffness of the spring 14 as a parameter. It should also be noted that, according to example implementations, the coils 18, 19 and 20 are connected to the evaluation circuit 16 of the sensor chip. The connection can be effected according to example implementations using conductor tracks in the metallization layer of the PCB.

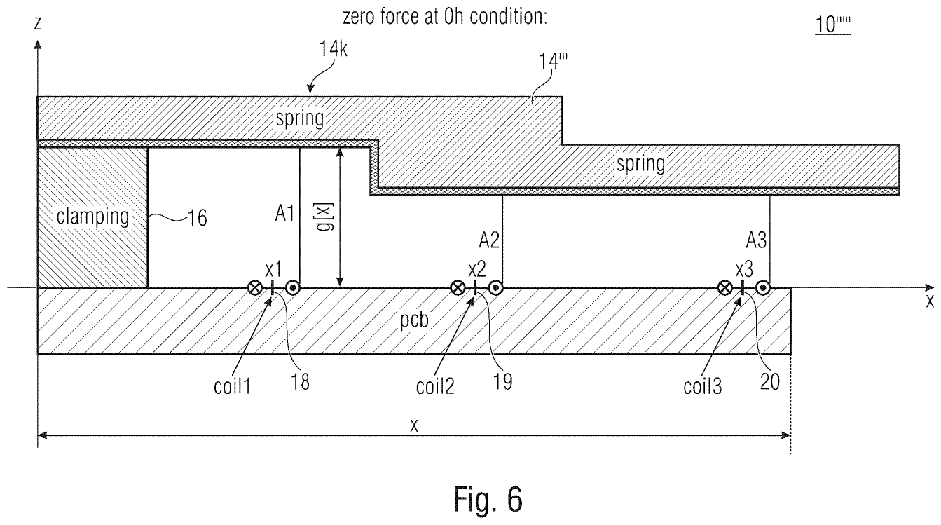

As shown, the lateral arrangement of the third coil 20 (position x3) may be in a region where the distance to the spring no longer changes during bending, or alternatively, of course, in a region, e.g., between x2 and x3, in which bending also takes place when force is applied. This means that all (or all three) coils are located under the freely flexible spring 14, as shown e.g., in FIG. 6 (note: here there is then no coil under the spring holder 16). It is irrelevant whether or not the distance of a coil changes—it is relevant that the distances change differently during sagging.

That is to say, according to example implementations, the force sensor 10′ may have a third coil 20 which is arranged at a third lateral position x3 along the deformation body at a third distance from the deformation body 14 and is configured to output a third measured value based on a size of the third distance A3 at the third lateral position, wherein the deformation of the deformation body changes the first, the second and the third distance differently. For example, the linear combination can be determined, while additionally considering the third measured value, using a third coefficient which is dependent on the stiffness. The constant c described above may be missing here.

The inductive principle is explained below in accordance with example implementations. For example, the evaluation circuit feeds an AC current into the coils 18, 19 and 20.

This generates a magnetic field that excites eddy currents in metal bodies exposed to the magnetic field (according to Faraday's law). These eddies generate their own magnetic field which counteracts the drive field (Lenz's law). This changes the magnetic flux that is coupled to the coil 18, 19, 20, and this changes the impedance of the coil 18, 19, 20, which is measured by the voltage (when a current is fed in—a voltage is measured. Alternatively, a voltage could be applied and the current response could be measured).

With respect to the element 14, it should be noted that the force F according to example implementations can be applied to the spring 14 at a well-defined position, e.g., defined by the projection 14v.

With regard to the spring, it should be noted that according to example implementations this has a defined stiffness which is co-determined by the mounting 16, the geometry, in particular the length x, of the lever arm and the profile of the cantilever element of the deformation body 14. The present shape is a bending stiffness resulting in the corresponding bending line. The coefficients for use in the function explained above, such as the linear function or the linear combination, are dependent on these stiffnesses (e.g., different positions along the x-axis) or the bending line. According to example implementations, these coefficients can be determined, for example, by at least one or preferably multiple measurements with differently defined forces F. The result is either the coefficients for multiplication by the respective measured values as well as any additional constants or alternatively also data, e.g., memories in a look-up table (LUT) containing the coefficients implicitly or in coded form. The look-up table can contain a multiplicity of data points, starting from which the bending line can be determined for the one or more defined states, such that further bending lines and the forces that cause them can be estimated.

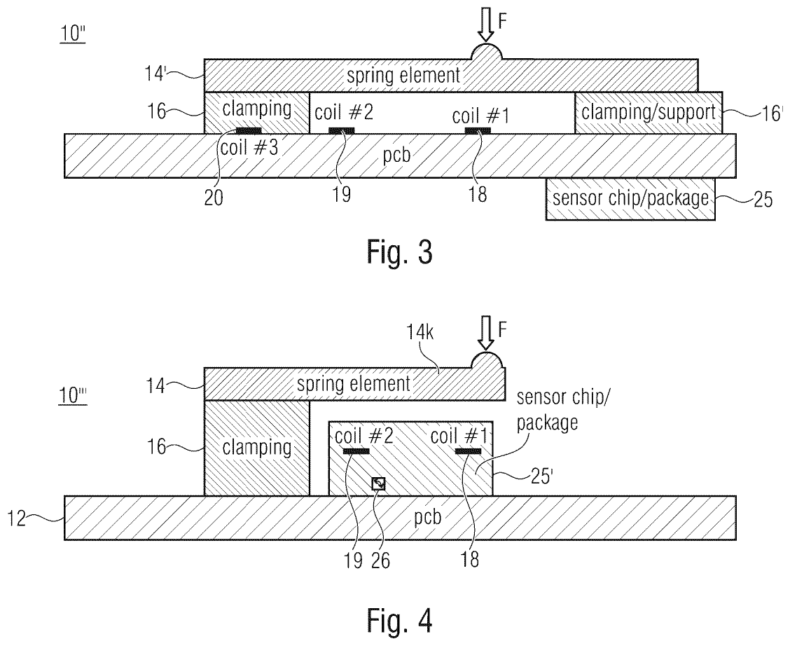

A further example implementation is now explained with reference to FIG. 3. FIG. 3 shows a sensor 10″ according to a further example implementation. The sensor 10″ represents a development of the sensor 10′ and substantially has a modified deformation element 14′. This is clamped on both sides for greater stiffness, e.g., by the support element 16 and the support element 16′ on a second side of the deformation element 14′. The coil 20 is arranged in the region of the support 16, while the coils 18 and 19 are provided between the supports 16 and 16′. As a result of the two-sided clamping, the deformation element 14′ is configured to undergo bending when force is applied k between the two supports 16 and 16′. Both 16 and 16′ can be supports, e.g., fixed connections to the deformation body 14′. Alternatively, it would also be conceivable for the deformation body 14′ to be clamped only on one side and for the second side, e.g., the side 16′, to be used as a carrier in order to balance the spring 14′ so that the spring 14′ can be moved laterally with respect to the element 16′ in the event of deflection. As a result, the element 14′ does not undergo bending due to the different length expansions under a thermal contraction of the PCB 12. Both variants have the advantage that the coils 18 and 19 are arranged in a cavity and thus there is good shielding or a good protective effect against environmental influences, such as iron chips or magnetic dust, in the effective range of the magnetic fields of the coils. Iron chips or magnetic dust can result in measurement errors which are excluded in this variant. According to a further example implementation, it would also be conceivable for the deformation body 14′ to be in the form of a type of plate or disk (generally: flat structure).

According to example implementations, the deformation body may comprise one or more of the following elements:
a spring;
a bending bar;
a cantilever;
an element which is arranged substantially parallel to a substrate or a printed circuit board or a straight line defined by the first and second coil;
a cranked or curved element, in particular a cranked or curved element with different distances at the first lateral position and the second lateral position;
an element clamped on one side;
an element clamped on two sides; and
a cover or a cap.

The cap is particularly advantageous because it protects the underlying coils and possibly also the chip and its fine bonding wires on all sides and is thus an integral part of the housing.

At this point, it should be noted that according to example implementations the sensor chip 25 or the package can also be arranged on side of the PCB 20 facing away from the spring 14′. Here in particular, this arrangement of the element 25 on the opposite side allows the advantage of saving lateral space.

FIG. 4 shows a further variant which represents a development of FIG. 1. The sensor 10′″ from FIG. 4 has the elements 12, 14 and 16, wherein the coils 18′ and 19′ are arranged directly in the element 25′. In this example implementation, the element 25′ with the coils 18 and 19 is provided in the lateral region of the cantilever 14k. Possible implementations of the arrangement of the coils 18 and 19 within the sensor package 25 are the provision of the separate substrate for the coils 18 and 19 with an additional evaluation chip 26 in the package 25 or alternatively the arrangement of the coils 18 and 19 directly in the semiconductor chip, which also includes the evaluation chip 26.

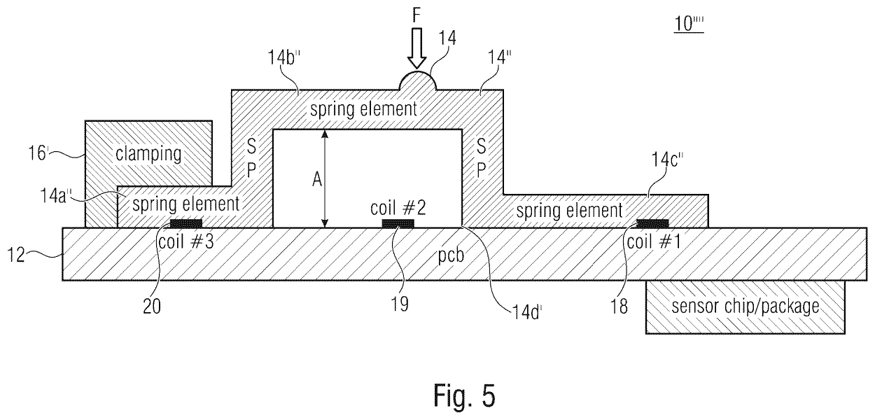

FIG. 5 shows a further sensor element with a cranked spring element 14″. This has two regions in a first plane directly adjacent to the surface of the PCB 12 (cf. reference signs 14a″ and 14c″) and an intermediate region 14b″. The region 14b″ is at the distance A from the PCB 12. The coil 18 is in the region 14c″, the coil 19 is in the region 14b″, and the coil 20 is in the region 14a″. In the region 14a″, the cranked deformation element 14″ is clamped by the element 16′ in relation to the PCB 12. Seen from another side, this means that the region 14c″ of the deformation body 14 is loose. When the force F acts on the projection 14v, the spring in the region 14b″ is pressed in the direction of the PCB 12 and thus approaches the coil 19. In the region 14c″, the spring raises, thus resulting here in a distance between the coil 18 and the region 14c″. The background is that a support is formed with respect to the PCB 12 between the regions 14b″ and 14c″, which support deflects the force as a transmission with a pivot point 14d′. The coil 20 is in turn provided in the region of the clamping 16′ and thus serves as a constant reference. Referring to FIGS. 6, 7 and 8, the evaluation carried out by the evaluation apparatus is now discussed and in particular also the consideration of possible imperfections in the structure, for example as a result of a gap between the PCB 12 and the surface of the deformation body 14″ (cf. FIG. 6), in which the distance values A1, A2 and A3 already vary in the idle state. Furthermore, the influence of tilting of the element 14′″ in relation to the PCB 12, which is already present in the idle state, is also discussed.

FIG. 6 shows a sensor arrangement 10″″ having a PCB 12 and three coils 18, 19 and 20 arranged on the PCB 12 at the positions x1, x2 and x3. The sensor arrangement has a deformation body 14′″ which extends from a clamping region 16 parallel to the PCB 12 and in turn has a cantilever 14k. The cantilever extends from the element 16 along the x-axis. In this variant, the three coils 18, 19 and 20 are all arranged in the region of the cantilever. Assuming that the deformation body 14′″ has a different surface profile on the side facing the gap, e.g., due to different thicknesses, the distance A varies over the positions x1, x2 and x3. The distances A2 and A3 at the positions x2 and x3 are approximately comparable in this variant, while the distance A1 at the position x1 is significantly larger. Starting from the different distances A1, A2 and A3, a gap with varying width is thus created and can be described by the function g(x).

In the following discussion, it is assumed that three coils 18, 19, 20 are arranged on PCB 12, e.g., along a line (x-axis) of a position x1<x2<x3 or along a planar curve on the PCB top side (s-axis) s1<s2<s3. The vertical direction is z. The inductances of the coils 18, 19 and 20 represent a function of the vertical distance A, or here designated d, between the coils 18, 19 and 20 and the metal spring 14′″.

The inductances of the three coils 18, 19, 20 are L1[d1], L2[d2], L3[d3]. The spring 14′″ could be flat and parallel to the PCB 12 (=preferred case), but generally it has any desired shape, such that the vertical distance between the flat PCB 12 and the spring 14′″ after the system has been assembled (=start of the service life) and at zero force is g[x], where g=gap=>g[x1], g[x2], g[x3] are the vertical distances between the coils 18, 19, 20 and the spring 14′″.

When a force is applied to the spring 14′″, it is deflected/bends. The bending line is the vertical displacement w*Fz as a function of the x-position: w[x]*Fz; the deflection/bending is proportional to the applied force Fz. The following thus applies: d[x]=g[x]−w[x]*Fz.

During the service life, the spring 14′″ may be displaced in the vertical direction (dz) and tilt its position due to thermal contraction and moisture swelling of the PCB 12, the spring 14′″ and other components (bolts, blocks, clamping apparatuses, etc.) (tilt angle=gamma).

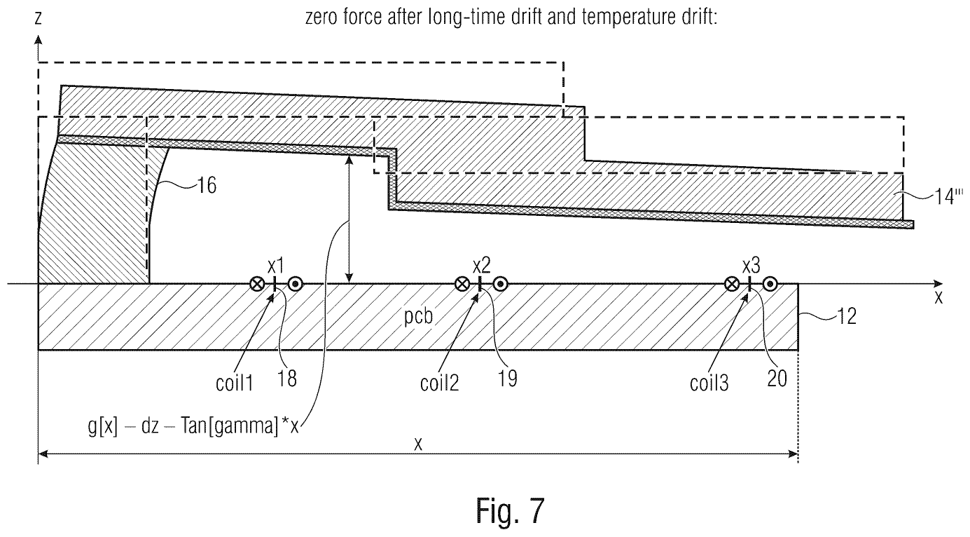

Such tilting and/or displacement starting from the force Fz is shown in FIG. 7.

In addition, the displacement and the tilting may vary with the applied force (for example if the PCB 12 and the clamping device are not perfectly stiff). For small displacements and tilting, the following applies: d[x]=g[x]−w[x]*Fz−dz−tan(gamma)*x.

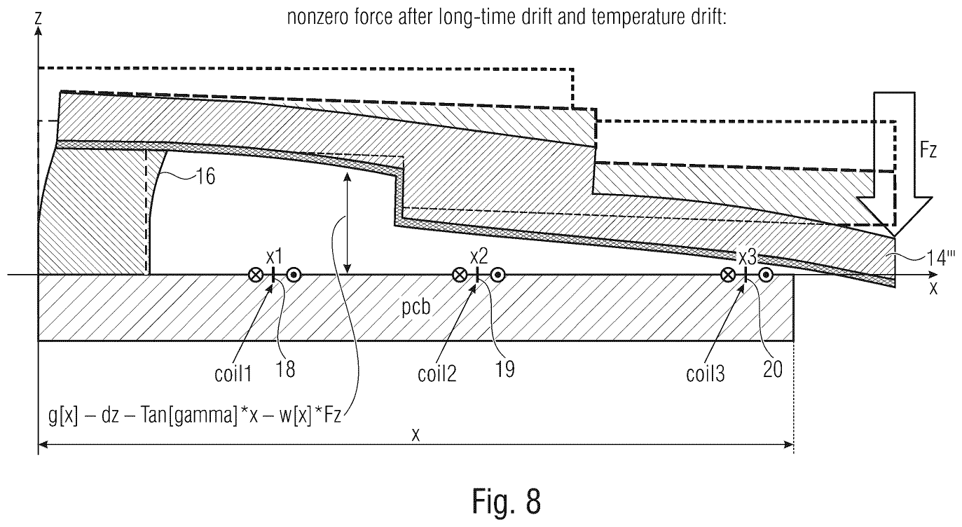

This situation is illustrated in FIG. 8.

It is assumed that each coil is connected to an inductance L1, L2, L3 with an associated capacitance C1, C2, C3 in order to give a resonant angular frequency ω1=1/sqrt(L1*C1); ω2=1/sqrt(L2*C2); ω3=1/sqrt(L3*C3).

This provides three equations:

$$1 / ω 1 \hat{} 2 / C 1 = L 1 [ g [ x 1 ] - {w [ x 1 ]}^{*} Fz - dz - {gamma}^{*} x 1 ]$$

$$1 / ω 2 \hat{} 2 / C 2 = L 2 [ g [ x 2 ] - {w [ x 2 ]}^{*} Fz - dz - {gamma}^{*} x 2 ]$$

$$1 / ω 3 \hat{} 2 / C 3 = L 3 [ g [ x 3 ] - {w [ x 3 ]}^{*} Fz - dz - {gamma}^{*} x 3 ]$$

The variables w, dz, gamma are small (small deflection/bending of the spring and small displacement and tilting of the spring). These are multiplied by s and the functions L1, L2, L3 are expanded in Taylor series in s to the first order:

For example, it follows for the first equation:

$$1 / omega 1 \hat{} 2 / C 1 - L 1 [ g [ x 1 ] - s * w [ x 1 ] * Fz * Cos [ s * gamma [ Fz ] ] - s * dz [ Fz ] - Tan [ s * gamma [ Fz ] ] * x 1 ] FullSimplify [ Series [ \% , \{ s , 0 , 1 \} ] ]$$

$$Out ( 2 ) = \frac{1}{C 1 omega {1}^{2}} - L 1 [ - s dz [ Fz ] + g [ x 1 ] - x 1 Tan [ sgamma [ Fz ] ] - Fz s Cos [ s gamma [ Fz ] ] w [ x 1 ] ]$$

$$Out ( 3 ) = ( \frac{1}{C 1 omega {1}^{2}} - L 1 [ g [ x 1 ] ] ) + ( dz [ Fz ] + x 1 gamma [ Fz ] + Fz w [ x 1 ) L {1}^{′} [ g [ x 1 ] ] s + {O [ s ]}^{2}$$

Then s=1 is set and this set of three linear equations is solved according to the three unknowns Fz, dz, gamma. The result is:

$$In [ \text{?} ] = FullSimplify [ Solve [ \{ ( \frac{1}{C 1 omega {1}^{2}} - L 1 [ g [ x 1 ] ] ) + ( dz + x 1 gamma + Fz w [ x 1 ] ) L {1}^{′} [ g [ x 1 ] ] = 0 , ( \frac{1}{C 2 omega {2}^{2}} - L 2 [ g [ x 2 ] ] ) + ( dz + x 2 gamma + Fz w [ x 2 ] ) L {2}^{′} [ g [ x 2 ] ] = 0 , ( \frac{1}{C 3 omega {3}^{2}} - L 3 [ g [ x 3 ] ] ) + ( dz + x 3 gamma + Fz w [ x 3 ] ) L {3}^{′} [ g [ x 3 ] = 0 \} , \{ Fz , dz , gamma \} ] ]$$

$$Out [ \text{?} ] = \{ \{ Fz \to ( C 2 C 3 omega {2}^{2} omega {3}^{2} ( x 2 - x 3 ) ( - 1 + C 1 omega {1}^{2} L 1 [ g [ x 1 ] ] ) L {2}^{′} [ g [ x 2 ] ] L {3}^{′} [ g ] [ x 3 ] ] + C 1 omega {1}^{2} L {1}^{′} [ g [ x 1 ] ] ( C 2 omega {2}^{2} ( x 1 - x 2 ) ( - 1 + C 3 omega {3}^{2} L 3 [ g [ x 3 ] ] ) L {2}^{′} [ g [ x 2 ] ] - C 3 omega {3}^{2} ( x 1 - x 3 ) ( - 1 + C 2 omega {2}^{2} L 2 [ g [ x 2 ] ] ) L {3}^{′} [ g [ x 3 ] ] ) ) / ( C 1 C 2 C 3 omega {1}^{2} omega {2}^{2} omega {3}^{2} ( ( x 2 - x 3 ) w [ x 1 ] + ( - x 1 + x 3 ) w [ x 2 ] + ( x 1 - x 2 ) w [ x 3 ] ) L {1}^{′} [ g [ x 1 ] ] L {2}^{′} [ g [ x 2 ] ] L {3}^{′} [ g [ x 3 ] ] ) , dz \to ( C 1 C 2 omega {1}^{2} omega {2}^{2} ( - 1 + C 3 omega {3}^{2} L 3 [ g [ x 3 ] ] ) ( x 2 w [ x 1 ] - x 1 w [ x 2 ] ) L {1}^{′} [ g [ x 1 ] ] L {2}^{′} [ g [ x 2 ] ] + C 3 omega {3}^{2} ( - C 1 omega {1}^{2} ( - 1 + C 2 omega {2}^{2} L 2 [ g [ x 2 ] ] ) ( x 3 w [ x 1 ] - x 1 w [ x 3 ] ) L {1}^{′} [ g [ x 1 ] ] + C 2 omega {2}^{2} ( - 1 + C 1 omega {1}^{2} L 1 [ g [ x 1 ] ] ) ( x 3 w [ x 2 ] - x 2 w [ x 3 ] ) L {2}^{′} [ g [ x 2 ] ] ) L {3}^{′} [ g [ x 3 ] ] ) / ( C 1 C 2 C 3 omega {1}^{2} omega {2}^{2} omega {3}^{2} ( ( x 2 - x 3 ) w [ x 1 ] + ( - x 1 + x 3 ) w [ x 2 ] + ( x 1 - x 2 ) w [ x 3 ] ) L {1}^{′} [ g [ x 1 ] ] L {2}^{′} [ g [ x 2 ] ] L {3}^{′} [ g [ x 3 ] ] ) , gamma \to ( - C 1 C 2 omega {1}^{2} omega {2}^{2} ( - 1 + C 3 omega {3}^{2} L 3 [ g [ x 3 ] ] ) ( w [ x 1 ] - w [ x 2 ] ) L {1}^{′} [ g [ x 1 ] ] L {2}^{′} [ g [ x 2 ] ] + C 3 omega {3}^{2} ( C 1 omega {1}^{2} ( - 1 + C 2 omega {2}^{2} L 2 [ g [ x 2 ] ] ) ( w [ x 1 ] - w [ x 3 ] ) L {1}^{′} [ g [ x 1 ] ] + C 2 omega {2}^{2} ( - 1 + C 1 omega {1}^{2} L 1 [ g [ x 1 ] ] ) ( - w [ x 2 ] + w [ x 3 ] ) L {2}^{′} [ g [ x 2 ] ] ) L {3}^{′} [ g [ x 3 ] ] ) / ( C 1 C 2 C 3 omega {1}^{2} omega {2}^{2} omega {3}^{2} ( ( x 2 - x 3 ) w [ x 1 ] + ( - x 1 + x 3 ) w [ x 2 ] + ( x 1 - x 2 ) w [ x 3 ] ) L {1}^{′} [ g [ x 1 ] ] L {2}^{′} [ g [ x 2 ] ] L {3}^{′} [ g [ x 3 ] ] ) \} \}$$

$$\text{?} \text{indicates text missing or illegible when filed}$$

This result is greatly simplified if all capacitances are set equal to CC, e.g., C1=CC, C2=CC, C3=CC, and if all inductances are set equal to LL at zero force, e.g., L1=LL, L2=LL, L3=LL, and if all derivatives are also set equal to Ls:

$$L {1}^{′} [ g [ x 1 ] ] = Ls , L {2}^{′} [ g [ x 2 ] ] = Ls , L {3}^{′} [ g [ x 3 ] ] = Ls$$

$$Then : Fz = \frac{\begin{matrix}omega {1}^{2} ( omega {2}^{2} ( - x 1 + x 2 ) + omega {3}^{2} ( x 1 - x 3 ) ) + \\ omega {2}^{2} omega {3}^{2} ( - x 2 + x 3 )\end{matrix}}{\begin{matrix}CC Ls omega {1}^{2} omega {2}^{2} omega {3}^{2} ( ( x 2 - x 3 ) w [ x 1 ] + \\ ( - x 1 + x 3 ) w [ x 2 ] + ( x 1 - x 2 ) w [ x 3 ] )\end{matrix}}$$

The resonant frequencies ω1, ω2, ω3 are measured by the electronic circuit of the inductive proximity sensor. All other parameters are given by the circuit design (CC) and mechanical structure (x1, x2, x3, w[x1], w[x2], w[x3]) and by both the circuit design and the mechanical structure (Ls).

Instead of omega1\hat{ }2, it is also possible to use 1/CC/Lm1; the same applies to omega2 and omega3: then the circuit must measure Lm1, Lm2, Lm3 (using devices from the prior art), instead of measuring the resonant frequencies (note: Lm1 is the inductance of the coil 18 when the spring is deflected, displaced and tilted, while L1[g[x1]] is the inductance of coil 1 at zero force, zero displacement and zero tilt):

$$FullSimplify [ ( omega {1}^{2} ( omega {2}^{2} ( - x 1 + x 2 ) + omega {3}^{2} ( x 1 - x 3 ) ) + omega {2}^{2} omega {3}^{2} ( - x 2 + x 3 ) ) / ( CC Ls omega {1}^{2} omega {2}^{2} omega {3}^{2} ( ( x 2 - x 3 ) w [ x 1 ] + ( - x 1 + x 3 ) w [ x 2 ] + ( x 1 - x 2 ) w [ x 3 ] ) ) / . \{ omega 1 \to 1 / Sqrt [ Lm 1 * CC ] , omega 2 \to 1 / Sqrt [ Lm 2 * CC ] , omega 3 \to 1 / Sqrt [ Lm 3 * CC ] \} , Lm 1 > 0 \&\& Lm 2 > 0 \&\& Lm 3 > 0 \&\& CC > 0 ]$$

$$( Lm 3 ( - x 1 + x 2 ) + Lm 2 ( x 1 - x 3 ) + Lm 1 ( - x 2 + x 3 ) ) / ( Ls ( ( x 2 - x 3 ) w [ x 1 ] + ( - x 1 + x 3 ) w [ x 2 ] + ( x 1 - x 2 ) w [ x 3 ] ) )$$

This is basically a linear combination Fz=k1*Lm1+k2*Lm2+k3*Lm3

where k1=(x3−x2/(Ls*((x2−x3)*w[x1]+(−x1+x3)*w[x2]+(x1−x2)*w[x3])); the same applies to k2 and k3. Thus, it can be seen that Fz is a linear combination of the three measured inductances Lm1, Lm2, Lm3, where the coefficients k1, k2, k3 depend on the bending w[x1], w[x2], w[x3], which is the smaller the stiffer the spring. The coefficients thus depend on the stiffness of the spring.

According to one example implementation, a sensor system having three coils, which are lined up on the x-axis or on an s-curve, e.g., position x1<x2<x3 or s1<s2<s3, is provided.

It measures the inductances Lm1, Lm2, Lm3 of the three coils 18, 19, 20 (for example using the resonant frequency or their impedance).

Finally, it calculates the externally applied mechanical force as a linear combination of the three inductances Lm1, Lm2, Lm3 using Fz=k1*Lm1+k2*Lm2+k3*Lm3, where the coefficients k1, k2, k3 are functions of the geometry and the spring bending line at a unit force.

The coefficients k1, k2, k3 can be determined empirically by applying multiple forces and measuring Lm1, Lm2, Lm3 and using a least squares method to determine the coefficients.

The system can be simplified easily if w[x1]=0. This means that the spring 14′″ above the coil 18, 19, 20 does not bend, but a common displacement dz is nevertheless allowed for the entire spring 14′″ (and dz can vary with the force Fz).

The system can be greatly simplified if either displacements or tilts can be excluded. Then only one of the parameters dz, gamma remains, and the other is zero. Therefore, there are only two unknowns here: one from dz, gamma and Fz. Only two equations are therefore needed to solve these unknowns and obtain Fz.

Therefore, the system requires only two coils 18, 19 (instead of three coils 18, 19, 20).

First case: dz=0. A system of two equations for the inductances of the two coils 18, 19 is then obtained (* dz=0: only two coils 18, 19*):

$$FullSimplify [ Solve [ \{ ( \frac{1}{C 1 omega {1}^{2}} - L 1 [ g [ x 1 ] ] ) + ( dz + x 1 gamma + Fz w [ x 1 ] ) L {1}^{′} [ g [ x 1 ] ] = 0 , ( \frac{1}{C 2 omega {2}^{2}} - L 2 [ g [ x 2 ] ] ) + ( dz + x 2 gamma + Fz w [ x 2 ] ) L {2}^{′} [ g [ x 2 ] = 0 \} /. dz \to 0 , \{ Fz , gamma \} ] ]$$

$$\{ \{ Fz \to - ( x 1 ( \frac{1}{C 2 omega {2}^{2}} - L 2 [ g [ x 2 ] ] ) L {1}^{′} [ g [ x 1 ] ] - x 2 ( \frac{1}{C 1 omega {1}^{2}} - L 1 [ g [ x 1 ] ] ) L {2}^{′} [ g [ x 12 ] ] ) / ( ( - x 2 w [ x 1 ] + x 1 w [ x 2 ] ) L {1}^{′} [ g [ x 1 ] ] L {2}^{′} [ g [ x 2 ] ] ) , gamma \to ( ( - 1 + C 1 omega {1}^{2} L 1 [ g [ x 1 ] ] ) w [ x 2 ] ) / ( C 1 omega {1}^{2} ( - x 2 w [ x 1 ] + x 1 w [ x 2 ] ) L {1}^{′} [ g [ x 1 ] ] ) + ( ( - 1 + C 2 omega {2}^{2} L 2 [ g [ x 2 ] ] ) w [ x 1 ] ) / ( C 2 omega {2}^{2} ( x 2 w [ x 1 ] - x 1 w [ x 2 ] ) L {2}^{′} [ g [ x 2 ] ] ) \} \}$$

$$FullSimplify [ \% /. \{ L {1}^{′} [ g [ x 1 ] ] \to L 1 s , L {2}^{′} [ g [ x 2 ] ] \to L 2 s \} ]$$

$$FullSimplify [ \% /. \{ L 1 [ g [ x 1 ] ] \to L 1 , L 2 [ g [ x 2 ] ] \to L 2 \} ]$$

$$FullSimplify [ \% /. \{ C 1 \to CC , C 2 \to CC \} ]$$

$$FullSimplify [ \% /. \{ L 1 \to LL , L 2 \to LL , L 1 s \to Ls , L 2 s \to Ls \} ]$$

$$FullSimplify [ \% /. \{ omega 1 \to 1 / Sqrt [ Lm 1 * CC ] , omega 2 \to 1 / Sqrt [ Lm 2 * CC ] \} , Lm 1 > 0 \&\& Lm 2 > 0 \&\& CC > 0 ]$$

$$\{ \{ Fz \to - ( \frac{L 1 s x 1}{C 2 omega {2}^{2}} - \frac{L 2 s x 2}{C 1 omega {1}^{2}} + L 2 s x 2 L 1 [ g [ x 1 ] ] - L 1 s x 1 L 2 [ g [ x 2 ] ] ) / ( L 1 s L 2 s ( - x 2 w [ x 1 ] + x 1 w [ x 2 ] ) ) , gamma \to ( C 1 L 1 s omega {1}^{2} ( - 1 + C 2 omega {2}^{2} L 2 [ g [ x 2 ] ] ) w [ x 1 ] + C 2 L 2 s omega {2}^{2} ( 1 - C 1 omega {1}^{2} L 1 [ g [ x 1 ] ] ) w [ x 2 ] ) / ( C 1 C 2 L 1 s L 2 s omega {1}^{2} omega {2}^{2} ( x 2 w [ x 1 ] - x 1 w [ x 2 ] ) ) \} \}$$

$$\{ \{ Fz \to - ( L 1 s ( - L 2 + \frac{1}{C 2 omega {2}^{2}} ) x 1 + L 2 s ( L 1 - \frac{1}{C 1 omega {1}^{2}} ) x 2 ) / ( L 1 s L 2 s ( - x 2 w [ x 1 ] + x 1 w [ x 2 ] ) ) , gamma \to ( C 1 L 1 s omega {1}^{2} ( - 1 + C 2 L 2 omega {2}^{2} ) w [ x 1 ] + C 2 L 2 s ( 1 - C 1 L 1 omega {1}^{2} ) omega {2}^{2} w [ x 2 ] ) / ( C 1 C 2 L 1 s L 2 s omega {1}^{2} omega {2}^{2} ( x 2 w [ x 1 ] - x 1 w [ x 2 ] ) ) \} \}$$

$$\{ \{ Fz \to - ( L 1 s ( - L 2 + \frac{1}{CC omega {2}^{2}} ) x 1 + L 2 s ( L 1 - \frac{1}{CC omega {1}^{2}} ) x 2 ) / ( L 1 s L 2 s ( - x 2 w [ x 1 ] + x 1 w [ x 2 ] ) ) , gamma \to ( L 1 s omega {1}^{2} ( - 1 + CC L 2 omega {2}^{2} ) w [ x 1 ] + L 2 s ( 1 - CC L 1 omega {1}^{2} ) omega {2}^{2} w [ x 2 ] ) / ( CC L 1 s L 2 s omega {1}^{2} omega {2}^{2} ( x 2 w [ x 1 ] - x 1 w [ x 2 ] ) ) \} \}$$

$$\{ \{ Fz \to - \frac{LL Ls ( - x 1 + x 2 ) + \frac{\text{?} ( \frac{\text{?}}{\text{?}} - \frac{\text{?}}{\text{?}} )}{CC}}{{Ls}^{2} ( - x 2 w [ x 1 ] + x 1 w [ x 2 ] )} , gamma \to ( omega {1}^{2} ( - 1 + CC LL omega {2}^{2} ) w [ x 1 ] + ( 1 - CC LL omega {1}^{2} ) omega {2}^{2} w [ x 2 ] ) / ( CC Ls omega {1}^{2} omega {2}^{2} ( x 2 w [ x 1 ] - x 1 w [ x 2 ] ) ) \} \}$$

$$\{ \{ Fz \to - \frac{LL x 1 - Lm 2 x 1 - LL x 2 + Lm 1 x 2}{Ls x 2 w [ x 1 ] - Ls x 1 w [ x 2 ]} , gamma \to ( LL w [ x 1 ] - Lm 2 w [ x 1 ] - LL w [ x 2 ] + Lm 1 w [ x 2 ] ) / ( Ls x 2 w [ x 1 ] - Ls x 1 w [ x 2 ] ) \} \}$$

$$\text{?} \text{indicates text missing or illegible when filed}$$

In this case. Fz is basically a linear combination of Lm1 and Lm2 plus an additive number k0

Second case: Set gamma=0. A system of two equations for the inductances of the two coils 18, 19 is then obtained (* gamma=0: only two coils 18, 19*):

$$FullSimplify ⌊ Solve [ \{ ( \frac{1}{C 1 omega {1}^{2}} - L 1 [ g [ x 1 ] ] ) + ( dz + x 1 gamma + Fz w [ x 1 ] ) L {1}^{′} [ g [ x 1 ] ] = 0 , ( \frac{1}{C 2 omega {2}^{2}} - L 2 [ g [ x 2 ] ] ) + ( dz + x 2 gamma + Fz w [ x 2 ] ) L {2}^{′} [ g [ x 2 ] ] = 0 \} /. gamma \to 0 , \{ Fz , dz \} ] ]$$

$$\{ \{ Fz \to - ( ( \frac{1}{C 2 omega {2}^{2}} - L 2 [ g [ x 2 ] ] ) L {1}^{′} [ g [ x 1 ] ] - ( \frac{1}{C 1 omega {1}^{2}} - L 1 [ g [ x 1 ] ] ) L {2}^{′} [ g [ x 2 ] ] ) / ( ( - w [ x 1 ] + w [ x 2 ] ) L {1}^{′} [ g [ x 1 ] ] L {2}^{′} [ g [ x 2 ] ] ) , dz \to ( \frac{( 1 - C 1 omega {1}^{2} L 1 [ g [ x 1 ] ] ) w [ x 2 ]}{C 1 omega {1}^{2} L {1}^{′} [ g [ x 1 ] ]} + \frac{( - 1 + C 1 {omega}^{2} L 2 [ g [ x 2 ] ] ) w [ x 1 ]}{C 2 omega {2}^{2} L {2}^{′} [ g [ x 2 ] ]} ) / ( w [ x 1 ] - w [ x 2 ] ) \} \}$$

$$FullSimplify [ \% /. \{ L {1}^{′} [ g [ x 1 ] ] \to L 1 s , L {2}^{′} [ g [ x 2 ] ] \to L 2 s \} ]$$

$$FullSimplify [ \% /. \{ L 1 [ g [ x 1 ] ] \to L 1 , L 2 [ g [ x 2 ] ] \to L 2 \} ]$$

$$FullSimplify [ \% /. \{ C 1 \to CC , C 2 \to CC \} ]$$

$$FullSimplify [ \% /. \{ L 1 \to LL , L 2 \to LL , L 1 s \to Ls , L 2 s \to Ls \} ]$$

$$FullSimplify [ \% /. \{ omega 1 \to 1 / Sqrt [ Lm 1 * CC ] , omega 2 \to 1 / Sqrt [ Lm 2 * CC ] \} , Lm 1 > 0 \&\& Lm 2 > 0 \&\& CC > 0 ]$$

$$\{ \{ Fz \to - ( - \frac{L 2 s}{C 1 omega {1}^{2}} + \frac{L 1 s}{C 2 omega {2}^{2}} + L 2 s L 1 [ g [ x 1 ] ] - L 1 s L 2 [ g [ x 2 ] ] ) / ( L 1 s L 2 s ( - w [ x 1 ] + w [ x 2 ] ) ) , dz \to ( \frac{( - 1 + C 2 omega {2}^{2} L 2 [ g [ x 2 ] ] ) w [ x 1 ]}{C 2 L 2 s omega {2}^{2}} + \frac{( \frac{1}{C \text{?} omega \text{?}} - L 1 [ g [ x 1 ] ] ) w [ x 2 ]}{L 1 s} ) / ( w [ x 1 ] - w [ x 2 ] ) \} \}$$

$$\{ \{ Fz \to - \frac{- L 1 s L 2 + L 1 L 2 s - \frac{L 2 s}{C 1 omega {1}^{2}} + \frac{L 1 s}{C 2 omega {2}^{2}}}{L 1 s L 2 s ( - w [ x 1 ] + w [ x 2 ] )} , dz \to ( \frac{( - 1 + C 2 L 2 omega {2}^{2} ) w [ x 1 ]}{C 2 L 2 s omega {2}^{2}} + \frac{( - L 1 + \frac{\text{?}}{C \text{?} omega \text{?}} ) w [ x 2 ]}{L 1 s} ) / ( w [ x 1 ] - w [ x 2 ] ) \} \}$$

$$\{ \{ Fz \to - \frac{- L 1 s L 2 + L 1 L 2 s - \frac{L 2 s}{CC omega {1}^{2}} + \frac{L 1 s}{CC omega {2}^{2}}}{L 1 s L 2 s ( - w [ x 1 ] + w [ x 2 ] )} , dz \to ( \frac{( - 1 + CC L 2 omega {2}^{2} ) w [ x 1 ]}{CC L 2 s omega {2}^{2}} + \frac{( - L 1 + \frac{\text{?}}{CC omega \text{?}} ) w [ x 2 ]}{L 1 s} ) / ( w [ x 1 ] - w [ x 2 ] ) \} \}$$

$$\{ \{ Fz \to \frac{( omega 1 - omega 2 ) ( omega 1 + omega 2 )}{CC Ls omega {1}^{2} omega {2}^{2} ( w [ x 1 ] - w [ x 2 ] )} , dz \to ( ( LL - \frac{1}{CC omega {2}^{2}} ) w [ x 1 ] + ( - LL + \frac{1}{CC omega {1}^{2}} ) w [ x 2 ] ) / ( Ls ( w [ x 1 ] - w [ x 2 ] ) ) \} \}$$

$$\{ \{ Fz \to \frac{- Lm 1 + Lm 2}{Ls ( w [ x 1 ] - w [ x 2 ] )} , dz \to \frac{( LL - Lm 2 ) w [ x 1 ] + ( - LL + Lm 1 ) w [ x 2 ]}{Ls ( w [ x 1 ] - w [ x 2 ] )} \} \}$$

$$\text{?} \text{indicates text missing or illegible when filed}$$

In this case, Fz is a linear combination of Lm1 and Lm2: Fz=k1*Lm1+k2*Lm2. At this point, it should again be noted that the mathematical explanations are only example and there may also be deviations in the calculation method.

In general, according to example implementations, this can be applied in such a way that the deformation body is separated from the first coil at least at the first lateral position s1 or x1 by a gap, or wherein the deformation body is separated from the first and second coil at least at the first lateral position s1 and x1 and the second lateral position s2 or x2 by a gap; the gap is described by a function g[x] along the deformation body and/or defined by the tilt angle gamma according to tan[gamma]=dg[x]/dx along the deformation body.

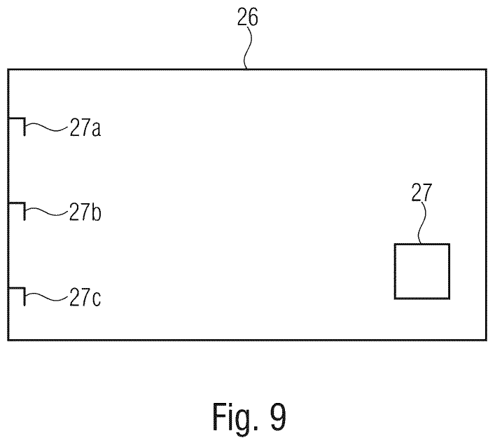

All example implementations have the feature in common that the evaluation apparatus 26, as shown in FIG. 9 with the inputs 27a, 27b and 27c, can determine or estimate the applied force Fz based on the at least two measurement signals at the coils 18 and 19 or the three measurement signals at the coils 18, 19 and 20 or also based on the measurement signal from more than three coils. For this purpose, a linear combination or generally a function of the measured inductances (Lm1, Lm2 or Lm1, Lm2 and Lm3) of at least two or three coils 18, 19 and 20 with the positions x1<x2<x3 or s1<s2<s3 is determined.

Either Fz=k0+k1*Lm1+k2*Lm2, where k0 could also be zero, or Fz=k1*Lm1+k2*Lm2+k3*Lm3, where each coefficient k0, k1, k2, k3 depends on the slope of an inductance relative to an x-coordinate for an applied zero force (=Ls) and on the mechanical stiffness of the spring 14′″ (implied in w[x1] . . . ).

The coefficients k0, k1, k2 and k3 depend on the stiffness of the spring. This means that, if the spring, e.g., 14′″, is replaced by a stiffer one, the coefficients must be adjusted. If the stiffness of the spring doubles, the coefficients double. This can be effected using calibration according to example implementations. Therefore, according to example implementations, the apparatus 26 may have a calibration apparatus that determines calibration data. In a further example implementation, the apparatus may also have only one memory for storing the calibration data. The calibration data can directly contain, for example, the coefficients k0, k1, k2 and k3, etc. or can also contain other values from which the coefficients can be derived. The coefficients generally describe from a mathematical point of view the distance change or inductance change in response to an acting force based on the spring stiffness(es). Alternative storage, such as the use of look-up tables, is possible in accordance with further example implementations. Preferably, at least one defined force is determined using the system in order to derive the calibration data therefrom. According to further example implementations, multiple force states with multiple defined forces can also be determined.

Even if in the above example implementations a structure on a PCB or in general a printed circuit board has always been assumed, it should be noted that according to alternative example implementations any kind of substrate can of course be present. According to example implementations, the force sensor has a substrate and/or a printed circuit board on which at least the first and/or second coil is arranged; wherein the first and/or second coil is cast in a package. Further, the second or a third coil may be arranged in a region in which the deformation body is clamped.

Although some aspects have been described in connection with an apparatus, it goes without saying that these aspects also constitute a description of the corresponding method, and so a block or a component of an apparatus should also be understood to be a corresponding method step or a feature of a method step. Analogously thereto, aspects which have been described in connection with a method step or as a method step also constitute a description of a corresponding block or detail or feature of a corresponding apparatus. Some or all of the method steps can be performed by a hardware apparatus (or using a hardware apparatus), such as a microprocessor, a programmable computer or an electronic circuit. In some example implementations, some or more of the most important method steps can be performed by such an apparatus.

Depending on certain implementation requirements, example implementations of the implementation may be implemented in hardware or software. The implementation can be performed using a digital storage medium, for example a floppy disk, a DVD, a Blu-ray disc, a CD, a ROM, a PROM, an EPROM, an EEPROM or a FLASH memory, a hard disk or another magnetic or optical memory, in which electronically readable control signals are stored that can interact or do interact with a programmable computer system such that the respective method is performed. For this reason, the digital storage medium can be computer-readable.

Some example implementations according to the implementation thus comprise a data carrier which has electronically readable control signals that are capable of interacting with a programmable computer system such that one of the methods described here is performed.

In general, example implementations of the present implementation can be implemented as a computer program product having a program code, wherein the program code acts to perform one of the methods if the computer program product is executed on a computer.

The program code can also be stored, for example, on a machine-readable carrier.

Other example implementations comprise the computer program for performing one of the methods described here, wherein the computer program is stored on a machine-readable carrier. In other words, an example implementation of the method according to the implementation is thus a computer program which has a program code for performing one of the methods described here if the computer program is executed on a computer.

A further example implementation of the methods according to the implementation is thus a data carrier (or a digital storage medium or a computer-readable medium), on which the computer program for performing one of the methods described here is recorded.

A further example implementation of the method according to the implementation is thus a data stream or a sequence of signals, which represents or represent the computer program for performing one of the methods described here. The data stream or the sequence of signals can be configured, for example, so as to be transferred via a data communication connection, for example the Internet.

A further example implementation comprises a processing device, for example a computer or a programmable logic device, which is configured or adapted for performing one of the methods described here.

A further example implementation comprises a computer, on which the computer program for performing one of the methods described here is installed.

A further example implementation according to the implementation comprises an apparatus or a system, which is configured to transmit a computer program for performing at least one of the methods described here to a receiver. The transmission can be electronic or optical, for example. The receiver can be, for example, a computer, a mobile device, a storage device or a similar apparatus. The apparatus or the system can comprise, for example, a file server for transmitting the computer program to the receiver.

In some example implementations, a programmable logic device (for example a field programmable gate array, FPGA) can be used to perform some or all functions of the methods described here. In some example implementations, a field programmable gate array can act together with a microprocessor to perform one of the methods described here. In general, the methods in some example implementations are performed by any desired hardware apparatus. The latter can be universally usable hardware, such as a computer processor (CPU) or hardware that is specific to the method, such as an ASIC.

The above-described example implementations are merely an illustration of the principles of the present implementation. It goes without saying that modifications and variations of the arrangements and details described here will be obvious to others skilled in the art. For this reason, the implementation is intended to be limited merely by the scope of protection of the following patent claims rather than by the specific details which have been presented based on the description and the explanation of the example implementations in this document.

### ASPECTS

The following provides an overview of some Aspects of the present disclosure:

Aspect 1: A force sensor, comprising: a deformation body configured to be subjected to a force and to undergo a deformation dependent on a stiffness of the deformation body under an influence of the force; a first coil arranged at a first lateral position along the deformation body at a first distance from the deformation body and is configured to form a first signal characteristic, which is described by a first measured value, based on a size of the first distance at the first lateral position; a second coil arranged at a second lateral position along the deformation body at a second distance from the deformation body and configured to form a second signal characteristic, which is described by a second measured value, based on a size of the second distance at the second lateral position, wherein the deformation of the deformation body changes the size of the first distance and the size of the second distance differently; and an evaluation circuit configured to determine the force as a function of at least the first measured value and the second measured value, including multiplying the first measured value by a first coefficient and multiplying the second measured value by a second coefficient, wherein the first coefficient and the second coefficient are dependent on the stiffness of the deformation body.

Aspect 2: The force sensor as recited in Aspect 1, wherein the first distance at the first lateral position varies based on the deformation of the deformation body, and wherein the second distance at the second lateral position varies based on the deformation of the deformation body.

Aspect 3: The force sensor as claimed in any of Aspects 1-2, wherein the function has a linear function, a predominantly linear function, a regionally linear function, or a quasi linear function.

Aspect 4: The force sensor as claimed in any of Aspects 1-3, wherein the force sensor has a third coil arranged at a third lateral position along the deformation body at a third distance from the deformation body and configured to output a third measured value based on a size of the third distance at the third lateral position, and wherein the deformation of the deformation body changes the first distance, the second distance, and the third distance differently.

Aspect 5: The force sensor as recited in Aspect 4, wherein the evaluation circuit is configure to determine a linear combination of the first measured value, the second measured value, and the third measured value, including using a third coefficient that is dependent on the stiffness.

Aspect 6: The force sensor as claimed in any of Aspects 1-5, wherein the first signal characteristic comprises a first resonant frequency, a first impedance, first inductance, or a first variable derived from the first resonant frequency, the first impedance, and/or the first inductance, and the second signal characteristic comprises a second resonant frequency, a second impedance, a second inductance, or a second variable derived from the second resonant frequency, the second impedance, and/or the second inductance.

Aspect 7: The force sensor as claimed in any of Aspects 1-6, wherein the deformation body has a conductive material, a conductive layer, and/or a conductive region.

Aspect 8: The force sensor as claimed in any of Aspects 1-7, wherein the deformation body is configured to undergo bending as the deformation or to be deformed according to a bending line that is dependent on the stiffness of the deformation body.

Aspect 9: The force sensor as claimed in any of Aspects 1-8, wherein at least the first distance at a first lateral position is dependent on the stiffness of the deformation body and a lever arm, and wherein the lever arm is defined by the first lateral position and a mounting position of the deformation body.

Aspect 10: The force sensor as claimed in any of Aspects 1-9, wherein the evaluation circuit is configured to excite the at least one of the first coil or the second coil with an alternating voltage signal, or measure a first impedance and second impedance as the first measured value and the second measured value, respectively.

Aspect 11: The force sensor as claimed in any of Aspects 1-10, wherein the deformation body comprises one or more of the following elements: a spring; a bending bar; a cantilever; an element which is arranged substantially parallel to a substrate, a printed circuit board, or a straight line defined by the first coil and the second coil; a cranked element or a curved element with different distances at the first lateral position and the second lateral position; an element clamped on one side; an element clamped on two sides; or a cover or a cap.

Aspect 12: The force sensor as claimed in any of Aspects 1-11, wherein the force sensor has a substrate or a printed circuit board on which the first coil and/or the second coil are arranged, and/or wherein the first coil and/or the second coil are molded in a package; and/or wherein the second coil or a third coil is arranged in a region in which the deformation body is clamped.

Aspect 13: The force sensor as claimed in any of Aspects 1-12, wherein the deformation body is separated from the first coil at least at the first lateral position by a gap, or wherein the deformation body is separated from the first coil and the second coil at least at the first lateral position and the second lateral position by a gap, and wherein the gap is described by a function g[x] along the deformation body and/or by an inclination angle gamma according to tan[gamma]=dg[x]/dx along the deformation body.

Aspect 14:

Aspect 15: The force sensor as recited in Aspect 1, further comprising: a permanent memory containing calibration data, from which the first coefficient and the second coefficient are derived or the function is adapted; and/or wherein the evaluation circuit has a calibration circuit which is configured to determine calibration data, from which the first coefficient and the second coefficient are derived or the function is adapted.

Aspect 16: An evaluation circuit for use with a force sensor, which has a deformation body, a first coil, and a second coil, wherein the deformation body is configured to be subjected to a force and to undergo a deformation dependent on a stiffness of the deformation body under an influence of the force, wherein the first coil is arranged at a first lateral position along the deformation body at a first distance from the deformation body and is configured to form a first signal characteristic, which is described by a first measured value, based on a size of the first distance at the first lateral position, wherein the second coil is arranged at a second lateral position along the deformation body at a second distance from the deformation body and is configured to form a second signal characteristic, which is described by a second measured value, based on a size of the second distance at the second lateral position, wherein the deformation of the deformation body changes the first distance and the second distance differently, wherein the evaluation circuit is configured to determine the force as a function of the first measured value and the second measured value, including multiplying the first measured value by a first coefficient and multiplying the second measured value by a second coefficient, and wherein the first coefficient and the second coefficient are dependent on the stiffness of the deformation body.

Aspect 17: A method for determining a force using a force sensor, which has a deformation body, a first coil, and a second coil, wherein the deformation body is configured to be subjected to a force and to undergo a deformation dependent on a stiffness of the deformation body under an influence of the force, wherein the first coil is arranged at a first lateral position along the deformation body at a first distance from the deformation body and is configured to form a first signal characteristic, which is described by a first measured value, based on a size of the first distance at the first lateral position, wherein the second coil is arranged at a second lateral position along the deformation body at a second distance from the deformation body and is configured to form a second signal characteristic, which is described by a second measured value, based on a size of the second distance at the second lateral position, wherein the first distance at the first lateral position varies based on the deformation of the deformation body, and wherein the deformation of the deformation body changes the first distance and the second distance differently, the method comprising: determining the force based on a linear combination of the first measured value and the second measured value, wherein the first measured value is multiplied by a first coefficient and the second measured value is multiplied by a second coefficient, and wherein the first coefficient and the second coefficient are dependent on the stiffness.

Aspect 18: A non-transitory computer-readable medium comprising a computer program having a program code for causing a processor to execute a method for determining a force using a force sensor, wherein the force sensor includes deformation body, a first coil, and a second coil, wherein the deformation body is configured to be subjected to a force and to undergo a deformation dependent on a stiffness of the deformation body under an influence of the force, wherein the first coil is arranged at a first lateral position along the deformation body at a first distance from the deformation body and is configured to form a first signal characteristic, which is described by a first measured value, based on a size of the first distance at the first lateral position, wherein the second coil is arranged at a second lateral position along the deformation body at a second distance from the deformation body and is configured to form a second signal characteristic, which is described by a second measured value, based on a size of the second distance at the second lateral position, wherein the first distance at the first lateral position varies based on the deformation of the deformation body, and wherein the deformation of the deformation body changes the first distance and the second distance differently, the method comprising: determining the force based on a linear combination of the first measured value and the second measured value, wherein the first measured value is multiplied by a first coefficient and the second measured value is multiplied by a second coefficient, and wherein the first coefficient and the second coefficient are dependent on the stiffness.

Aspect 19: A force sensor, comprising: a deformation body configured to be subjected to a force and to undergo a deformation dependent on a stiffness of the deformation body under an influence of the force; a first coil arranged at a first lateral position along the deformation body at a first distance from the deformation body and is configured to form a first signal characteristic, which is described by a first measured value, based on a size of the first distance at the first lateral position; and a second coil arranged at a second lateral position along the deformation body at a second distance from the deformation body and configured to form a second signal characteristic, which is described by a second measured value, based on a size of the second distance at the second lateral position, wherein the deformation of the deformation body changes the size of the first distance and the size of the second distance differently.

Aspect 20: A system configured to perform one or more operations recited in one or more of Aspects 1-19.

Aspect 21: An apparatus comprising means for performing one or more operations recited in one or more of Aspects 1-19.

Aspect 22: A non-transitory computer-readable medium storing a set of instructions, the set of instructions comprising one or more instructions that, when executed by a device, cause the device to perform one or more operations recited in one or more of Aspects 1-19.

Aspect 23: A computer program product comprising instructions or code for executing one or more operations recited in one or more of Aspects 1-19.

1. A force sensor (10, 10′, 10″, 10′″, 10″″, 10′″″) having the following features:
a deformation body (14, 14′, 14″, 14′″) which is designed to be subjected to a force and to undergo a deformation dependent on a stiffness of the deformation body (14, 14′, 14″, 14′″) under the influence of the force;
at least a first coil (18) which is arranged at a first lateral position (x1, s1) along the deformation body (14, 14′, 14″, 14′″) at a first distance (A1) from the deformation body (14, 14′, 14″, 14′″) and is designed to form a first signal characteristic, which is described by a first measured value, on the basis of a size of the first distance (A1) at the first lateral position (x1, s1); and
a second coil (19) which is arranged at a second lateral position (x2, s2) along the deformation body (14, 14′, 14″, 14′″) at a second distance (A2) from the deformation body (14, 14′, 14″, 14′″) and is designed to form a second signal characteristic, which is described by a second measured value, on the basis of a size of the second distance (A2) at the second lateral position (x2, s2);
wherein the deformation of the deformation body (14, 14′, 14″, 14′″) changes the first and the second distance (A1, A2) differently;
wherein the force can be determined by an evaluation circuit (26) which is designed to determine the force as a function of at least the first measured value and the second measured value, wherein the first measured value is multiplied by a first coefficient and the second measured value is multiplied by a second coefficient, wherein the first and the second coefficient are dependent on the stiffness of the deformation body (14, 14′, 14″, 14′″).

2. The force sensor (10, 10′, 10″, 10′″, 10″″, 10′″″) as claimed in claim 1, wherein at least the first distance (A1) at the first lateral position (x1, s1) varies on the basis of the deformation of the deformation body (14, 14′, 14″, 14′″), and/or wherein the second distance (A2) at the second lateral position (x2, s2) varies on the basis of the deformation of the deformation body (14, 14′, 14′, 14′″).

3. The force sensor (10, 10′, 10″, 10′″, 10″″, 10′″″) as claimed in one of the preceding claims, wherein the function has a linear function, a predominantly linear function, a regionally linear function or a quasi linear function.

4. The force sensor (10, 10′, 10″, 10′″, 10″″, 10′″″) as claimed in one of the preceding claims, wherein the force sensor (10, 10′, 10″, 10′″, 10″″, 10′″″) has a third coil (20) which is arranged at a third lateral position (x3, s3) along the deformation body (14, 14′, 14″, 14′″) at a third distance (A3) from the deformation body (14, 14′, 14″, 14′″) and is designed to output a third measured value on the basis of a size of the third distance (A3) at the third lateral position (x3, s3), wherein the deformation of the deformation body (14, 14′, 14″, 14′″) changes the first (A1), the second (A2) and the distance (A3) differently.

5. The force sensor (10, 10′, 10″, 10′″, 10″″, 10′″″) as claimed in claim 4, wherein the linear combination is determined, while additionally considering the third measured value, using a third coefficient which is dependent on the stiffness.

6. The force sensor (10, 10′, 10″, 10′″, 10″″, 10′″″) as claimed in one of the preceding claims, wherein the first signal characteristic comprises a first resonant frequency or impedance or inductance (Lm1) or a first variable derived therefrom and the second signal characteristic comprises a second resonant frequency or impedance or inductance (Lm2) or a first variable derived therefrom.

7. The force sensor (10, 10′, 10″, 10′″, 10″″, 10′″″) as claimed in one of the preceding claims, wherein the deformation body (14, 14′, 14″, 14′″) has a conductive material and/or a conductive layer and/or a conductive region.

8. The force sensor (10, 10′, 10″, 10′″, 10″″, 10′″″) as claimed in one of the preceding claims, wherein the deformation body (14, 14′, 14″, 14′″) is designed to undergo bending as deformation or to be deformed according to a bending line that is dependent on the stiffness.

9. The force sensor (10, 10′, 10″, 10′″, 10″″, 10′″″) as claimed in one of the preceding claims, wherein at least the first distance (A1) at a first lateral position (x1, s1) is dependent on the stiffness of the deformation body (14, 14′, 14″, 14′″) and a lever arm, wherein the lever arm is defined by the first lateral position (x1, s1) and a position of the mounting of the deformation body (14, 14′, 14″, 14′″).

10. The force sensor (10, 10′, 10″, 10′″, 10″″, 10′″″) as claimed in one of the preceding claims, wherein the evaluation circuit (26) is designed to excite the first and/or second coil (19) with an alternating voltage signal and/or to measure a first and second impedance as the first and the second measured value.

11. The force sensor (10, 10′, 10″, 10′″, 10″″, 10′″″) as claimed in one of the preceding claims, wherein the deformation body (14, 14′, 14″, 14′″) comprises one or more of the following elements:
a spring;
a bending bar;
a cantilever;
an element which is arranged substantially parallel to a substrate or a printed circuit board or a straight line defined by the first and second coil (19);
a cranked or curved element, in particular a cranked or curved element with different distances at the first lateral position (x1, s1) and the second lateral position (x2, s2);
an element clamped on one side;
an element clamped on two sides; and
a cover or cap.

12. The force sensor (10, 10′, 10″, 10′″, 10″″, 10′″″) as claimed in one of the preceding claims, wherein the force sensor (10, 10′, 10″, 10′″, 10″″, 10′″″) has a substrate and/or a printed circuit board on which at least the first and/or second coil (19) is arranged; and/or
wherein the first (18) and/or second coil (19) is molded in a package; and/or
wherein the second (19) or a third coil (20) is arranged in a region in which the deformation body (14, 14′, 14″, 14′″) is clamped.

13. The force sensor (10, 10′, 10″, 10′″, 10″″, 10′″″) as claimed in one of the preceding claims, wherein the deformation body (14, 14′, 14″, 14′″) is separated from the first coil (18) at least at the first lateral position s1 or x1 by a gap, or wherein the deformation body (14, 14′, 14″, 14′″) is separated from the first (18) and second coil (19) at least at the first lateral position s1 or x1 and the second lateral position s2 or x2 by a gap; and
wherein the gap is described by a function g[x] along the deformation body (14, 14′, 14″, 14′″) and/or by the inclination angle gamma according to tan[gamma]=dg[x]/dx along the deformation body (14, 14′, 14″, 14′″).

14. The force sensor (10, 10′, 10″, 10′″, 10″″, 10′″″) as claimed in one of the preceding claims, which comprises an evaluation circuit (26).

15. The force sensor (10, 10′, 10″, 10′″, 10″″, 10′″″) as claimed in one of the preceding claims, which has a permanent memory containing calibration data, from which the at least first and the second coefficient can be derived or the function can be adapted; and/or
wherein the evaluation circuit (26) has a calibration circuit (27) which is designed to determine calibration data, from which the at least first and the second coefficient can be derived or the function can be adapted.

16. An evaluation circuit (26) for use with a force sensor (10, 10′, 10″, 10′″, 10″″, 10′″″), which has a deformation body (14, 14′, 14″, 14′″), at least a first coil (18) and a second coil (19), wherein the deformation body (14, 14′, 14″, 14′″) is designed to be subjected to a force and to undergo a deformation dependent on a (bending) stiffness of the deformation body (14, 14′, 14″, 14′″) under the influence of the force, wherein the first coil (18) is arranged at a first lateral position (x1, s1) along the deformation body (14, 14′, 14″, 14′″) at a first distance (A1) from the deformation body (14, 14′, 14″, 14′″) and is designed to form a first signal characteristic, which is described by a first measured value, on the basis of a size of the first distance (A1) at the first lateral position (x1, s1); and wherein the second coil (19) is arranged at a second lateral position (x2, s2) along the deformation body (14, 14′, 14″, 14′″) at a second distance (A2) from the deformation body (14, 14′, 14″, 14′″) and is designed to form a second signal characteristic, which is described by a second measured value, on the basis of a size of the second distance (A2) at the second lateral position (x2, s2); wherein the deformation of the deformation body (14, 14′, 14″, 14′″) changes the first and the second distance (A2) differently;
wherein the evaluation circuit (26) is designed to determine the force as a function of at least the first measured value and the second measured value, wherein the first measured value is multiplied by a first coefficient and the second measured value is multiplied by a second coefficient, wherein the first and the second coefficient are dependent on the stiffness of the deformation body (14, 14′, 14″, 14′″).

17. A method for determining a force using a force sensor (10, 10′, 10″, 10′″, 10″″, 10′″″), which has a deformation body (14, 14′, 14″, 14′″), at least a first coil (18) and a second coil (19), wherein the deformation body (14, 14′, 14″, 14′″) is designed to be subjected to a force and to undergo a deformation dependent on a (bending) stiffness of the deformation body (14, 14′, 14″, 14′″) under the influence of the force; wherein the first coil (18) is arranged at a first lateral position (x1, s1) along the deformation body (14, 14′, 14″, 14′″) at a first distance (A1) from the deformation body (14, 14′, 14″, 14′″) and is designed to form a first signal characteristic, which is described by a first measured value, on the basis of a size of the first distance (A1) at the first lateral position (x1, s1); and wherein the second coil (19) is arranged at a second lateral position (x2, s2) along the deformation body (14, 14′, 14″, 14′″) at a second distance (A2) from the deformation body (14, 14′, 14″, 14′″) and is designed to form a second signal characteristic, which is described by a second measured value, on the basis of a size of the second distance (A2) at the second lateral position (x2, s2); wherein at least the first distance (A1) at the first lateral position (x1, s1) varies on the basis of the deformation of the deformation body (14, 14′, 14″, 14′″), and wherein the deformation of the deformation body (14, 14′, 14″, 14′″) changes the first (A1) and the second distance (A2) differently; comprising the following step of:
determining the force based on a linear combination of at least the first measured value and the second measured value, wherein the first measured value is multiplied by a first coefficient and the second measured value is multiplied by a second coefficient, wherein the first and the second coefficient are dependent on the stiffness.

18. A computer program for carrying out the method as claimed in claim 17 when the method is carried out on a processor.
